(19) United States
(12) Patent Application Publication
(10) Pub. No.: US 2024/0322904 A1
(43) Pub. Date: Sep. 26, 2024

(54) A METHOD FOR DETERMINING INFORMATION ASSOCIATED WITH AN OPTICAL COMPONENT SYSTEM

(71) Applicant: Telefonaktiebolaget LM Ericsson (publ), Stockholm (SE)

(72) Inventors: Sergio MOSTI, Genova (IT); Claudio D'INCÀ, Genova (IT); Alberto DEHO, Genova (IT); Roberto MAGRI, Genova (IT); Fabio CAVALIERE, Pisa (IT); Paolo DEBENEDETTI, Genova (IT)

(21) Appl. No.: 18/574,211

(22) PCT Filed: Jun. 30, 2021
(86) PCT No.: PCT/EP2021/068094

§ 371 Date: Dec. 26, 2023

(51) Int. Cl. H04B 10/071; G01M 11/00; G01M 11/08

(52) U.S. Cl. CPC H04B 10/071; G01M 11/088; G01M 11/3127

(57) ABSTRACT

Embodiments described herein relate to methods and apparatuses for determining information associated with an optical component system in a network. A method for determining information associated with an optical component system in a network, wherein the optical component system includes a first optical path for transmission of a first optical signal, wherein the first optical path operates in an optical bandwidth that is different from a traffic optical bandwidth of a traffic optical path, includes: detecting at least one mechanically introduced optical loss in the transmitted first optical signal; and based on the detected at least one mechanically introduced optical loss, determining information associated with the optical component system.

### TECHNICAL FIELD

Embodiments described herein relate to methods and apparatuses for determining information associated with an optical component system in a network, wherein the optical component system comprises a first optical path for transmission of a first optical signal, wherein the first optical path operates in an optical bandwidth that is different from a traffic optical bandwidth of a traffic optical path. Embodiments described herein also relate to a fiber presser. Embodiments described herein also relate to an optical component system.

### BACKGROUND

DWDM (Dense Wavelength Division Multiplexing)/CWDM (Coarse Wavelength Division Multiplexing) techniques make efficient use of an optical fiber in a network, and allow for the simultaneous transmission of multiple channels on a single fiber by utilizing different optical signals at different frequencies or wavelengths. This is enabled by the availability of lasers that can produce different frequencies, and by passive optical components that are able to Mux and Demux these frequencies.

In a single fiber working mode, both transmission and reception occur over one fiber, and in dual fiber working mode, transmission channels occur on one fiber, and reception channels occur on another fiber. Passive optical components are available for both these working modes, and they are typically hosted in a dedicated trail or cassette.

Typically, passive optical components are not provided with inventory indications. It is not therefore currently possibly to automatically discover the network topology after installation. In order to discover the network topology, the installation of power cables and a management network would be required for these purely passive units, and this would increase operating and capital expenditure.

Optical time domain reflectometer (OTDR) technology is widely used for fault finding and troubleshooting in optical networks. Additionally, tunable compact OTDRs in small form-factor pluggable (SFP) format are becoming available at a reasonable cost.

It will be appreciated that optical components are often hosted in dedicated cassettes, or enclosures, which are purely passive units. In other words, optical components are often hosted in units in which no electrical power is required for the optical operation of the unit, and where no inventory information for the unit is therefore automatically available for the network controller.

It will also be appreciated that optical components are typically deployed in unmanned sites, or fiber junction points, of a network, with no power supply and no access to the management plane. In these circumstances, to read any inventory information related to the optical component, and to identify the optical component with its own specifications a site visit would be required. Additionally, the use of a Radio-frequency identification (RFID) for an optical component would also require a site visit. It will be appreciated that such site visits are time consuming, and may not always possible.

It will be appreciated that, to allow the topology of optical components within a network to be discovered, electronic devices may be provided within the optical component, or within the enclosures surrounding the optical component, that allow the optical component to be discovered through network management. However, this provision of electrical power and a management connection to the optical component (or the enclosure) may result in additional costs for the network operator, particularly in situations where these power and/or management connections are not already present for the optical component (or the enclosure).

Presently, the topology of the optical components within a network may be discovered by maintaining an offline map of the passive optical network. This solution for discovering the topology of the optical components within a network cannot identify which ports of an optical component are effectively connected to which fiber in the network. Thus, an operator of the network would have to physically discover these optical components within the passive optical network, and additionally discover how these optical components are connected to fibers within the network, in order to build a map of the passive optical network. It will be appreciated that this physical checking process would then need to be repeated over time in order to maintain the offline map, as the topology of the network may vary over time. For example, in Centralized Radio Access Network (CRAN) applications, in which services over different bands can be added to the network quite often. It will be appreciated that this maintenance of the offline map is only possible with site inspection and optical fiber labelling, as the optical components are deployed in the optical distribution frame and in unmanned sites without power supply and management interfaces. Additionally, the operator can verify the component characteristics using complex test instrumentation that must be connected to each fiber, and that must also disconnect the traffic. Thus, this operation can only be performed within a maintenance window, and must not be performed frequently as the operation affects the traffic.

As noted previously, an electrical part may be added to either the component cassette or the trail, in order to retrieve inventory information that allows the unit to be identified. It will be appreciated that, for certain units, such as an indoor central office installation, a power and/or management connection may be easily available, although adding these connections to the cassette (or unit), and the provision of the necessary electronics for identification of the unit, will increase the cost of the unit itself. Alternatively, for other units, such as an outdoor application, in addition to the increased cost of the unit, power and management cabling may need to additionally be provided for this existing passive unit, and may result in an unacceptable increase of operating and capital expenditure.

In another example, multiple optical reflectors may be integrated in the optical components to identify network branches in a limited manner in a passive optical network. However, these optical reflectors are discrete, and must be specifically manufactured and combined with the optical component in a production process. Additionally, these optical reflectors are not reconfigurable in the field. Furthermore, detecting these optical reflectors requires a very high spatial resolution for the OTDR.

In another example, a Fiber Bragg Grating may be used to reflect different wavelengths that are related to individual optical components. However, in order to resolve reflection on different wavelengths, an OTDR with multiple laser sources would be required, or other advanced features. Furthermore, the Fiber Bragg Gratings are not in field reconfigurable.

### SUMMARY

According to some embodiments there is provided a method for determining information associated with an optical component system in a network, wherein the optical component system comprises a first optical path for transmission of a first optical signal, wherein the first optical path operates in an optical bandwidth that is different from a traffic optical bandwidth of a traffic optical path. The method comprises detecting at least one mechanically introduced optical loss in the transmitted first optical signal; and based on the detected at least one mechanically introduced optical loss, determining information associated with the optical component system.

According to some embodiments there is provided an OTDR for determining information associated with an optical component system in a network, wherein the optical component system comprises a first optical path for transmission of a first optical signal, wherein the first optical path operates in an optical bandwidth that is different from a traffic optical bandwidth of a traffic optical path. The OTDR comprises a processor and a memory, and the memory contains instructions executable by the processor such that the OTDR is operable to: detect at least one mechanically introduced optical loss in the transmitted first optical signal; and based on the detected at least one mechanically introduced optical loss, determine information associated with the optical component system.

According to some embodiments there is provided a fiber presser. The fiber presser comprises a housing for directing an optical fiber; and a plurality of projections, wherein each of the plurality of projections are moveable between a first position in which the projection induces a mechanical optical loss along an optical fiber, and a second position in which the projection does not induce a mechanical optical loss along the optical fiber.

According to some embodiments there is provided an optical component system. The optical component system comprises: a first optical path, wherein the first optical path comprises a fiber presser configured to induce at least one optical loss along the first optical path, wherein the first optical path operates in an optical bandwidth that is different from a traffic optical bandwidth of a traffic optical path; and a traffic optical path operating in the traffic optical bandwidth, wherein the traffic optical path comprises an optical component.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a method 100 for determining information associated with an optical component in a network;

FIG. 2 shows a Front Haul System with SFP OTDR 200 and Optical Component cascading;

FIG. 3 illustrates an example of an optical component system 300;

FIG. 4 illustrates an additional example of an optical component system 400;

FIG. 5 illustrates an example power profile 500 obtained by an OTDR 200 executing the method 100; and

FIGS. 6a and 6b illustrate a fiber presser 600;

FIG. 7 illustrates a part of fiber presser 700;

FIGS. 8a and 8b illustrates an optical component cassette 800;

FIG. 9 is a schematic of an example of an apparatus 900 for determining information associated with an optical component system in a network.

### DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Aspects of the present disclosure provide methods and apparatuses that allow a passive optical network topology to be discovered, and that also allow optical component systems to be identified by discovering encoded information related to the optical component systems along an additional optical path. Additionally, aspects of the present disclosure provide methods and apparatuses that allow for the determination of a location of an optical component system along the additional optical path based on the discovered encoded information.

Aspects of the present disclosure additionally do not require electrical parts for optical component system identification, and enable a purely passive optical method to identify and/or locate optical component systems in an optical network.

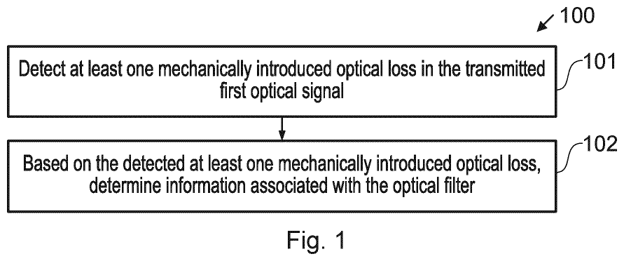

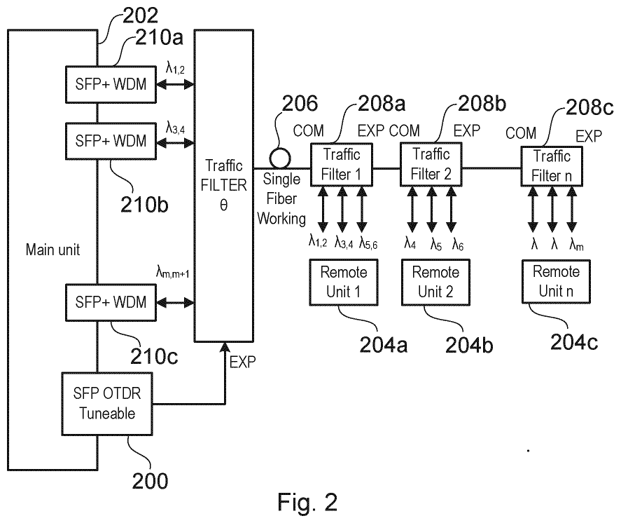

FIG. 1 illustrates a method 100 for determining information associated with an optical component system in a network, wherein the optical component system comprises a first optical path for transmission of a first optical signal, wherein the first optical path operates in an optical bandwidth that is different from a traffic optical bandwidth of a traffic optical path. The method 100 may be executed by an OTDR (for example, OTDR 200 as illustrated in FIG. 2). However, it will be appreciated that the method 100 may be executed by any suitable apparatus.

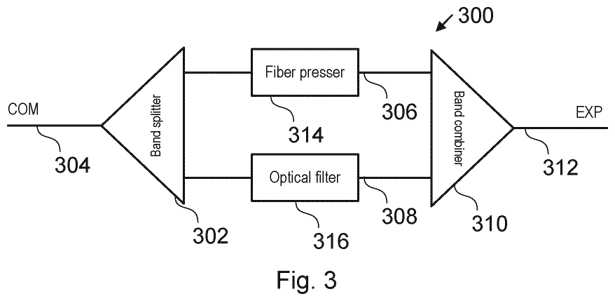

The optical component system may comprise an optical component system 300 as described with reference to FIG. 3 below.

It will be appreciated that the first optical path may be interchangeably referred to as an optical coding path, or an additional optical path. It will also be appreciated that the optical paths and traffic path referred to herein may be comprised in separate optical fibers, or alternatively, may be comprised in the same optical fiber.

It will be appreciated that the network as referred to in this disclosure may comprise a point-to-point (P2P) network, or a multipoint network. Additionally, the network may be a single fiber, or a dual fiber, network.

In step 101, at least one mechanically introduced optical loss in the transmitted first optical signal is detected. In some aspects, a plurality of mechanically introduced optical losses are detected.

In some embodiments, each of the at least one mechanically introduced optical loss may have a magnitude in a range of 0.5-1 dB. However, it will be appreciated that the magnitude of the mechanically induced optical losses may be any suitable value that may, for example, depend on the span loss and the accuracy of the method of detecting the mechanically induced optical losses. For example, in some embodiments, the step of detecting at least one mechanically introduced optical loss in the transmitted first optical signal may comprise detecting at least one optical loss in a reflection of the first optical signal.

In step 102, based on the detected at least one mechanically introduced optical loss, information associated with the optical component system is determined.

It will be appreciated that by inducing and detecting mechanically induced optical losses in a first optical path that is distinct from the traffic optical path, these mechanically induced optical losses will result in minimal disruption to the traffic that is transmitted along the traffic optical path. In some embodiments, the first optical path may operate in an optical bandwidth of 1300-1500 nm. Alternatively, in other embodiments, the first optical path may operate in an optical bandwidth of 1600-1650 nm. In some embodiments, the traffic optical path operates in an optical bandwidth of 1520 nm-1570 nm. It will be appreciated that the first optical path may operate in any suitable optical bandwidth that is distinguished from the optical bandwidth in which the traffic optical path operates.

In some embodiments, the information may comprise location information. In these embodiments, the step of determining location information associated with the optical component system may comprise: determining a distance at which the at least one mechanically introduced optical loss in the first optical path occurred; and based on the determined distance, determining location information associated with the optical component system. In other words, the distance at which the at least one mechanically introduced optical loss in the first optical path occurs may be used to determine the distance along the first optical path at which said optical component system is located. An example of how the location of the optical component system may be determined from the at least one mechanically introduced optical loss is described in more detail with reference to FIG. 2.

Additionally, in some embodiments, the method may further comprise, based on the determined distance, determining identification information associated with the optical component system, wherein the identification information is also associated with the determined distance. In other words, the distance at which the at least one mechanically introduced optical loss occurs along the path may then be correlated to a particular optical component system. Therefore, both the location and the identification of an optical component system may be determined by the at least one mechanically introduced optical loss.

In some embodiments, the information may comprise identification information. In these embodiments, the step 101 of detecting at least one mechanically introduced optical loss in the transmitted first optical signal may comprise detecting a plurality of mechanically introduced optical losses in the first optical path of the optical component system. Additionally, the step of determining location information associated with the optical component system may comprise, based on the detected plurality of mechanically introduced optical losses, determining identification information associated with the optical component system.

For example, in some embodiments, the detected plurality of mechanically introduced optical losses in the first optical path may encode the aforementioned identification information. For example, in some embodiments, the encoded identification information may correspond to a binary encoding. For example, the presence or lack thereof of a mechanical loss may be interpreted as a “1” or a “0” in a binary code respectively. It will be appreciated that such encoded identification information may then correspond to a specific optical component system in the network, and may allow said optical component system to be identified. Thus, in some embodiments, the identification information may be encoded by the detected plurality of mechanically introduced optical losses. As such, aspects of the disclosure provide for determining information associated with the optical component system, wherein the information is encoded by the mechanically introduced optical losses.

In some embodiments, a step of determining the identification information may comprise determining whether the plurality of mechanically introduced optical losses have been detected within a predetermined distance range. It will be appreciated that this step may allow it to be determined that the plurality of mechanically introduced optical losses are sufficiently closely spaced in order to relate to the same optical component system.

In some embodiments, a step of determining the identification information may comprise decoding encoded identification information by determining whether a mechanically introduced loss has occurred at defined points along in the first optical path. It will be appreciated that the combination of the detection of the mechanically introduced optical losses, and the distances at which they occur, may allow further, or additional, information related to an optical component system to be encoded. It will be appreciated that the defined points at which the losses occur may be evenly spaced in some embodiments, or alternatively, may not be evenly spaced in other embodiments.

In some embodiments, the defined points are based on a pattern of mechanically introduced optical losses that would encode the identification information. That is, in some embodiments, a pattern corresponding to the detected plurality of mechanically introduced optical losses may be compared with one or more patterns that respectively correspond to encoded identification information, in order to decode the encoded identification information.

The defined points along an optical path may be defined relative to an initial mechanically introduced optical loss. The initial mechanically introduced optical loss may be representative of the closest possible distance to the OTDR that the optical component system is able to introduce an optical loss. This initial mechanically introduced optical loss may also be used to determine the location of the optical component system, as described above.

In some embodiments, a step of determining the identification information may comprise decoding encoded identification information by determining the distance between the mechanically introduced losses.

An example of how a plurality of mechanical losses may be utilized to encode information is described in more detail with reference to Table 1 below.

It will be appreciated that, in some embodiments, the identification information may comprise an Optical-MAC address. In some embodiments, the Optical-MAC address may identify one or more ports of an optical component system.

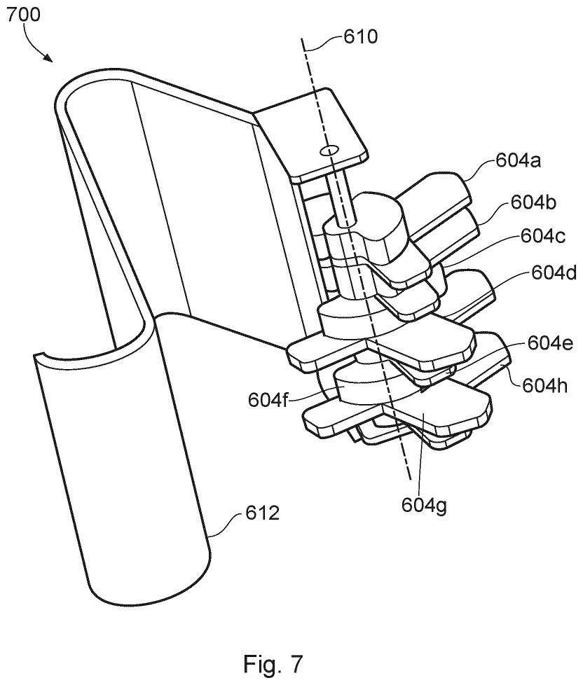

In some embodiments, the method 100 may be utilized to discover multiple and consecutive passive optical devices within the same optical network, by implementing a time-correlation between reflected optical pulses and detected mechanically induced optical losses. This is described in greater detail with reference to FIG. 7.

Thus, the method 100 may allow a specific optical coding assigned to a specific optical component system to be discovered, therefore allowing said optical component system to be identified in the network. For example, in some embodiments by combining the distance at which a first mechanically induced optical loss is detected, and any further mechanically induced optical losses and the distance at which they occur, identifying information related to an optical component system, and the position of the optical component system in the first optical path, may be determined.

FIG. 2 shows a Fronthaul system with a OTDR 200 (in this example a SFP OTDR 200) and cascading optical filters.

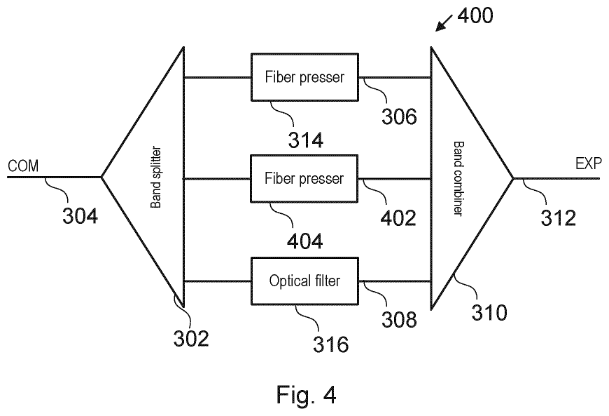

In a generic Fronthaul Network, a Main Unit 202 is efficiently connected to remote units 204a, 204b, 204c through a single fiber 206, and specific traffic optical filters 208a, 208b, 208c allow multiple services to be combined in that single fiber 206. The combination of the Main Unit 202 and remote units 204a, 204b, 204c provide service connection to other equipment, such as BB and Radio (FrontHaul) or Routers (Backhaul). It will be appreciated that each of the traffic optical filters 208a, 208b, 208c may form part of an optical component system according to FIG. 3 or FIG. 4, as described below.

The Main Unit 202 in this example, is configured to multiplex signals from m different WDM outputs 210a to 210c. A traffic filter 212 may then multiplex the signals over a single fiber 206.

Traffic filters typically operate in bandwidth of 1500-1600 nm, as well the standard SFP DWDM that manages those wavelengths. It will be appreciated that other wavelengths may be considered, for example, CWDM in a second window. It will be appreciated that the first optical path described herein is configured to operate in an optical bandwidth that is different from a traffic optical bandwidth. For example, where the traffic optical path is CWDM (and operates at a bandwidth of substantially 1310 nm), the first optical path may operate in a bandwidth of substantially 1550 nm.

The OTDR 200 of FIG. 2 may execute the method 100 of FIG. 1. It will be appreciated that the OTDR 200 may execute the method 100 (and thus, discover the live topology of the optical component systems of the network) in response to a command issued to the Main Unit, for example, by a network operator or management node.

The OTDR 200 operates in a different optical bandwidth to the bandwidth of the traffic channels (for example, the OTDR may operator in a bandwidth of 1400-1500 nm). In other words, the OTDR source wavelength may be within the bandwidth in which the first optical path operates. Hence the OTDR 200 may execute the method 100 in a manner that avoids interference with the traffic channels. Thus, the execution of the method 100 by the OTDR 200 may be performed without interrupting or stopping traffic within the network.

It will be appreciated that the SFP OTDR 200 may be installed inside an appropriate SFP cage that is available on an appropriate optical component unit. For example, an FH6622 unit comprises 4 general purpose ports where an SFP OTDR 200 could be inserted.

It will be appreciated that the OTDR 200 may be able to detect optical losses of, for example, up to one dB over a distance of, for example, 1-2 metres. Thus, the OTDR 200 is suitable to detect mechanically induced optical losses according to the method 100 described above.

FIG. 3 illustrates an example of an optical component system 300. It will be appreciated that part of the method 100 may be performed in accordance with the optical component system 300. It will be appreciated, that an optical component system 300 may be located at each of the remote units 204a, 204b, 204c as described with reference to FIG. 2.

The optical component system comprises a first optical path 306 and a traffic optical path 308. The first optical path comprises an optical fiber presser 314 configured to induce at least one optical loss along the first optical path. The traffic optical path 308 comprises an optical component 316.

It will be appreciated that in some embodiments, the optical component 316 may comprise a passive optical component (that may be able to Mux and Demux different frequencies, for example). In some embodiments, the optical component 316 may comprise an optical filter. For example, in some embodiments, the optical component 316 may correspond to a traffic optical filter 208a, 208b, 208c as described with reference to FIG. 2.

As noted above, the first optical path 306 operates in an optical bandwidth that is different from a traffic optical bandwidth in which the traffic optical path 308 operates. Providing an optical component system having two optical paths operating in different bandwidths (a first path comprising a fiber presser for introducing optical losses, and a second path for carrying the traffic) allows for the OTDR as described with reference to FIG. 2 to perform the method of FIG. 1. In particular, the provision of two optical paths allows for the mechanically introduced optical losses to be utilized without affecting the transmission of the traffic.

In the illustrated example, the optical component system 300 comprises a first band splitter 302, connected to an input optical path 304. The input optical path 304 may comprise a standard optical fiber. The first band splitter 302 is configured to separate the input optical path 304 into the first optical path 306, and the traffic optical path 308. It will be appreciated that the aforementioned first optical signal will therefore be transmitted from the input optical path 304 along the first optical path 306 via the first band splitter 302. The optical component system 300 further comprises a first band combiner 310, for combining the first optical path 306 and the traffic optical path 308 to form an output optical path 312.

It will be appreciated that the first band splitter 302, and the first band combiner 310 may correspond to the same technology and/or material that is presently within the optical component 316.

In FIG. 3, the optical component system 300 comprises the first band splitter 302 for separating the first optical path 306 and the traffic optical path 308. However, it will be appreciated that, in other embodiments, the optical component system 300 may not comprise a first band splitter 302 for separating the first optical path 306 and the traffic optical path 308, and may for example, be supplied by the first optical path 306 and the traffic optical path 308 themselves (as opposed to the input optical path 304). It will be appreciated that in this example, the band combiner 310 would also not be required, and the output optical path 312 would also be replaced by the first optical path 306 and the traffic optical path 308.

As noted above, it will be appreciated that by inducing and detecting mechanically induced optical losses in a first optical path that is distinct from the traffic optical path, these mechanically induced optical losses will result in minimal disruption to the traffic that is transmitted along the traffic optical path. For example, in some embodiments, the first optical path 306 may operate in an optical bandwidth of 1300-1500 nm. Alternatively, in other embodiments, the first optical path 306 may operate in an optical bandwidth of 1600-1650 nm. In some embodiments, the traffic optical path 308 operates in an optical bandwidth of 1520 nm-1570 nm. It will be appreciated that the first optical path 306 may operate in any suitable optical bandwidth that is distinguished from the optical bandwidth in which the traffic optical path 308 operates.

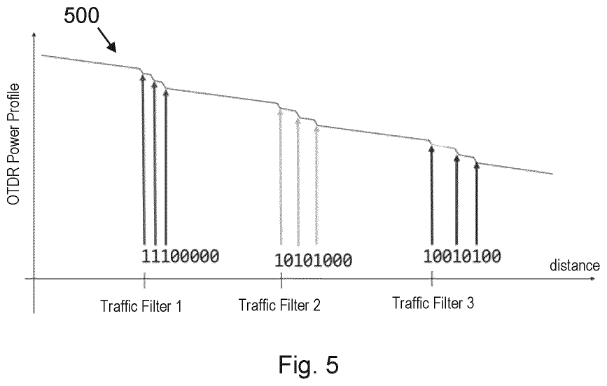

The fiber presser 314 may correspond to the fiber presser 500 as described later with reference to FIG. 5.

FIG. 4 illustrates an additional example of an optical component system 400. It will be appreciated that part of the method 100 may be performed in accordance with the optical component system 400.

The optical component system 400 corresponds largely to the optical component system 300, and the same reference numerals have been used to illustrate corresponding elements of the optical component system 400.

The optical component system 400 comprises a first band splitter 302, connected to an input optical path 304. The input optical path 304 may comprise a standard optical fiber. The first band splitter 302 is configured to separate the input optical path 304 into a first optical path 306, a second optical path 402, and a traffic optical path 308. It will be appreciated that the first optical path 306 and the second optical path 402 operate in distinct optical bandwidths, and these two distinct optical bandwidths are also different from the traffic optical bandwidth in which the traffic optical path 308 operates. The optical component system 400 further comprises a first band combiner 310, for combining the first optical path 306, the second optical path 402, and the traffic optical path 308 to form an output optical path 312.

The first optical path 306 comprises a fiber presser 314 that is configured to induce at least one optical loss along the first optical path 306. Additionally, the traffic optical path 308 comprises an optical component 316 (e.g. an optical filter). Furthermore, the second optical path 402 comprises a second fiber presser 404 that is configured to induce at least one optical loss along the second optical path 402. It will be appreciated that the fiber presser 314 and the second fiber presser 404 may both correspond to the fiber presser 500 of FIG. 5.

It will be appreciated that the first band splitter 302, and the first band combiner 310 may correspond to the same technology and/or material that is presently within the optical component 316.

It will be appreciated that, in some embodiments, the optical component system 400 may not comprise a first band splitter 302 or a first band combiner 310, in accordance with the reasoning described above with reference to FIG. 3.

As noted above, it will be appreciated that by inducing and detecting mechanically induced optical losses in a first optical path that is distinct from the traffic optical path, these mechanically induced optical losses will result in minimal disruption to the traffic that is transmitted along the traffic optical path. For example, in some embodiments, the first optical path 306 may operate in an optical bandwidth of 1300-1500 nm, and the second optical path 402 may operate in an optical bandwidth of 1600-1650 nm. In some embodiments, the traffic optical path 308 operates in an optical bandwidth of 1520 nm-1570 nm. It will be appreciated that the first optical path 306 and the second optical path 402 may operate in any suitable optical bandwidth that are distinguished from both the optical bandwidth in which the traffic optical path 308 operates, and that are distinguished from one another.

It will be appreciated that this provision of a second optical path along which optical losses may be mechanically induced may allow further, or additional, information related to the optical component system to be encoded. For example, distinct information such as an O-MAC address, a manufacturer tag, a supplier tag, a Serial Number (S/n) tag and/or a Part Number (P/n) tag may be encoded by providing the appropriate number of optical paths operating in distinct bandwidths, and an appropriate number of fiber pressers to encode information along these optical paths.

Examples of determined identification information for 3 different optical component systems are now presented in below in Table 1.

| | Coding Path 1 | Coding Path 2 | Coding Path 3 |
|---|---|---|---|
| Fiber Presser | For Filter 1 | For Filter 2 | For Filter 3 |
| Setting | OMD-24 | OAD-3-S-A | OAD-3-S-B |
| LOSS 1 | 1 | 1 | 1 |
| LOSS 2 | 1 | 0 | 0 |
| LOSS 3 | 1 | 1 | 0 |
| LOSS 4 | 0 | 0 | 1 |
| LOSS 5 | 0 | 1 | 0 |
| LOSS 6 | 0 | 0 | 1 |
| LOSS 7 | 0 | 0 | 0 |
| LOSS 8 | 0 | 0 | 0 |

In this illustrated example, for each optical component system, there are 8 possible mechanical losses that can be introduced at 8 known distances (or known relative distances) along the optical path. The presence, or lack thereof, of a mechanically introduced optical loss at each of the 8 known distances may be used to provide an 8 bit binary code. If a mechanically induced optical loss is measured at a particular distance, then this bit be determined as a “1”, and alternatively, if no mechanically induced optical loss is measured then the bit may be determined as a “0”. Hence, the measured mechanically induced optical losses can be used to determine a binary coding. This determined binary coding can then be used to determine an identity of the optical component system along the first optical path. It will be appreciated that, in the example in table 1, the 3 different binary codings correspond to 3 different configurations of the fiber presser 600 that forms part of each optical component system, where the different configurations induce optical losses in different locations along the first optical path. In some embodiments, the optical fiber may be looped to allow defined optical losses to be encoded at different distances along the first optical path (optical fiber) within a compact area. In some embodiments, the mechanically configured pattern of “1”s and “0”s at a particular node location may be used to encode information relating to that equipment or node. For example, encoded information may comprise a O-MAC address, a node identity, or a manufacturer tag. That is, in some embodiments, the information associated with an optical component system may relate to the optical component comprised within the optical component system.

It will also be appreciated, that in the example illustrated in table 1, the first possible mechanical loss “LOSS 1” is always set to 1. This is so that the positioning of the possible mechanical losses is altered to the OTDR. If for example, LOSS 1 was set to 0 for filter 1, the OTDR may mistakenly understand the mechanical loss occuring at LOSS 2 to be the first bit in the encoding. In some examples, the fiber presser generates a plurality of optical losses. The distance between the two or more optical losses encodes information about a co-located optical component.

FIG. 5 shows an example power profile 500 obtained by an OTDR 200 executing the method 100 described above.

It can be seen in the power profile 500, that each time a loss in the measured power is detected by the OTDR 200, it is determined that a “1” occurs in the encoded information for the respective component systems. It is also shown that, over a predetermined distance (that is measured from the previous determined encoded number), if no loss in the measured power is detected by the OTDR 200, it is determined that a “0” occurs in the encoded information (at the respective distance along the first optical path) for the respective component systems.

It will be appreciated that information relating to multiple consecutive component systems along the first optical path may be determined using one transmitted optical signal along the first optical path. It will be appreciated that either the knowledge of the distance along the first optical path at which each component system (or the corresponding component) is located, and/or the detection of a new loss in the measured power of a magnitude associated with a mechanically induced optical loss occurring following a previous encoding, may be utilised to determine a new encoding in the measured power profile 500. In other words, combining the measured optical losses, and the distances at which these losses occur along the first optical path, may be utilised to identify multiple component systems along the first optical path.

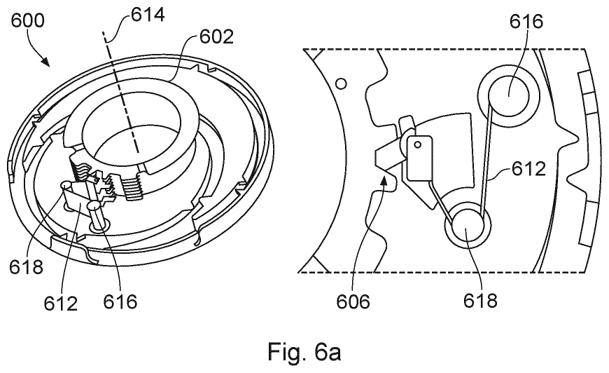

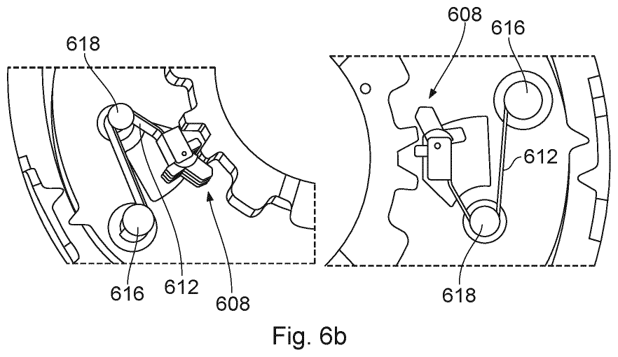

FIGS. 6a and 6b illustrate a fiber presser 600. The fiber presser 600 may be used in the optical component systems 300 and 400 described above. FIG. 7 illustrates a part of fiber presser 700 in greater detail. The same reference numerals have been used to illustrate corresponding elements of the fiber presser 600, and the part of the fiber presser 700.

The fiber presser 600 comprises a housing 602. The housing 602 is suitable for directing an optical fiber, for example, the first optical path 306 of FIG. 3. In this embodiment, the housing 602 is configured to coil the optical fiber around a second axis 614. In some embodiments, the housing 602 may allow 10-16 m of optical fiber to be directed.

The fiber presser 600 further comprises a plurality of projections 604a-604h. In this particular embodiment, fiber presser 600 comprises 8 projections. It will be appreciated that a fiber presser 600 may comprise any suitable number of projections. In some examples, the more projections provided the greater number of bits that may be provided in a resulting binary code. Each of the plurality of projections 604a-604h are moveable between a first position 606, in which the projection induces a mechanical optical loss along an optical fiber, and a second position 608 in which the projection does not induce a mechanical optical loss along the optical fiber. It will be appreciated that in this embodiment, when in the first position, each of the plurality of projections will physically act on an optical fiber so as to induce an optical loss.

In some embodiments, the plurality of projections may be configured to induce mechanical optical losses along the optical fiber that encode information along the optical fiber. That is, in some embodiments, in which an optical component system comprises the aforementioned fiber presser, the configuration of the plurality of projections of the fiber presser may encode information that can then be associated with the optical component system.

It will be appreciated that as each of the plurality of projections 604a-604h are moveable between the first position 606 and the second position 608, the mechanical losses induced by these projections, and therefore, the information encoded by these losses, may be easily varied.

In this embodiment, the each of the plurality of projections 604a-604h are rotatable about a first axis 610 between the first position 606 and the second position 608. However, it will be appreciated that, in other embodiments, the plurality of projections 604a-604h may be moveable between the first position 606 and the second position 608 in any suitable manner. In this embodiment, the plurality of projections 604a-604h are mounted adjacent to one another in a direction 610 parallel to the second axis 614.

In other examples, the housing may direct the optical fiber along a line, and the projections may be positioned spaced apart along the direction of the optical fiber.

The fiber presser 600 further comprises a biasing element 612 that is configured to bias the plurality of projections 604a-604h to remain in either the first position 606 or the second position 608. A user may therefore move each of the projections 604a-604h from the first position 606 to a second position 608 by exerting some force to overcome the effects of the biasing element 612. In this embodiment, the fiber presser further comprises columns 616 and 618 which act as fulcrums for the biasing element 612. It will be appreciated that the biasing element 612 may be formed of any suitable material (for example, such as steel, or another metallic material) that allows that plurality of projections 604a-604h to be effectively biased.

In this embodiment, the plurality of projections 604a-604h are therefore positioned such that, when in the first position 606, the plurality of projections produce optical losses at evenly spaced points along the optical fiber. However, it will be appreciated that, in other embodiments, the plurality of projections may be positioned such that, when in the first position 606, the plurality of projections produce optical losses at defined points along the optical fiber, and that these defined points may not necessarily be evenly spaced.

In some examples, the position at which a projection introduces an optical loss may be variable. For example, in the example in which the housing directs the optical fiber along a line, and the projections moveable along the direction of the optical fiber. The variable distances between the mechanically induced optical losses may be used to encode the information associated with the optical component system, or may be used to allow further, or additional, information related to the optical component system to be encoded. It will be appreciated that these optical losses may be induced at variable distances by either directing the optical path in a particular manner, or varying the positions and/or structure of the plurality of projections, such that the first position of each of the plurality of projections is then also varied.

In some embodiments, the plurality of projections 604a-604h are therefore positioned such that, when in the first position 606, the plurality of projections generate optical losses every 1-2 meters. Additionally, in this embodiment, the plurality of projections induce optical losses of approximately 0.5-1 dB respectively. It will be appreciated that optical losses of this order of magnitude, and separated by distances of this order, may be detectable by the example OTDR 200 of FIG. 2 executing the method 100 of FIG. 1.

As noted above, these controlled optical losses may then be detected as part of the method 100, and used to determine information (such as location and or identification information) relating to the optical component system.

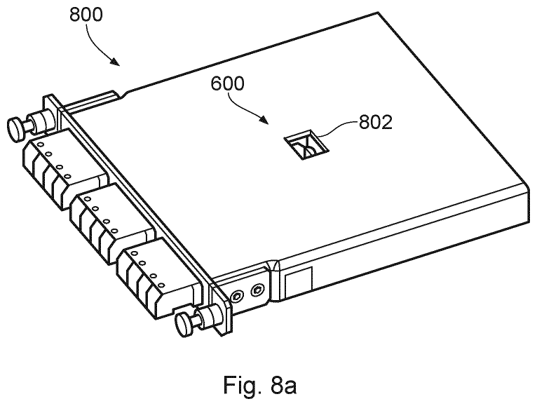

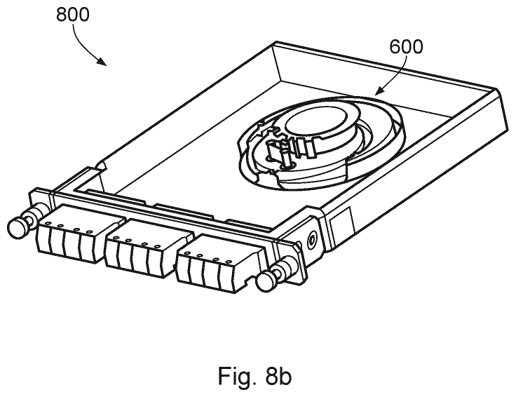

FIGS. 8a and 8b illustrates an optical component cassette 800 according to some embodiments.

The cassette 800 comprises a structure 300 or 400, in particular the fiber presser 600, according to FIG. 6 above. It is noted that the optical components and the band splitters of the structures 300 or 400 are not illustrated in FIGS. 8a and 8b. It will be appreciated that the fiber presser 600 is of the appropriate dimensions to be easily integrated inside an existing optical component system, for example, the optical filter system FH6020, or the optical filter system FH6080.

The cassette 800 further comprises a window 802. This window 802 allows the fiber presser 600 to be accessed easily, for example, for to allow for a user to adjust the positions of the plurality of projections 604a-604h (and to change to information that is encoded by the positions of the plurality of projections 604a-604h. For example, when a optical component system is installed, a user may set the identification of the optical component system by inputting the identification in binary code using the plurality of projections.

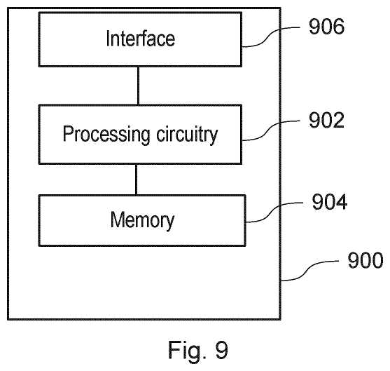

FIG. 9 is a schematic of an example of an apparatus 900 (for example, an OTDR) for determining information associated with an optical component system in a network, wherein the optical component system comprises a first optical path for transmission of a first optical signal, wherein the first optical path operates in an optical bandwidth that is different from a traffic optical bandwidth of a traffic optical path. The apparatus 900 comprises processing circuitry 902 (e.g. one or more processors) and a memory 904 in communication with the processing circuitry 902. The memory 904 contains instructions executable by the processing circuitry 902. The apparatus 900 may also comprise an interface 906 in communication with the processing circuitry 902. Although the interface 906, processing circuitry 902 and memory 904 are shown connected in series, these may alternatively be interconnected in any other way, for example via a bus.

In one embodiment, the memory 904 contains instructions executable by the processing circuitry 902 such that the apparatus 900 is operable to detect at least one mechanically introduced optical loss in the transmitted first optical signal, and based on the detected at least one mechanically introduced optical loss, determine information associated with the optical component system. In some examples, the apparatus 900 is operable to carry out the methods 100 described above with reference to FIG. 1.

Embodiments described herein therefore provide optical component systems comprising an additional optical path, operating in a different bandwidth to the bandwidth in which the traffic path operates. Additionally, attenuation along this additional optical path can be configured manually such that detectable optical losses occur along the path in defined positions. Embodiments described herein also provide methods for discovering optical component systems in a network utilising this additional optical path, whereby the optical losses that occur along the path may be configured for each optical component system, and thereby encode information associated with each component system. Such encoding may be detected using a reflected optical signal along the additional optical path. This detected encoded information may then be used to identify and locate passive optical components in the optical network.

It will be appreciated that the introduction of a fiber presser as described above, is of negligible additional cost for the network operator, and induces negligible optical loss on the traffic optical path. Additionally, the fiber presser as described above is reconfigurable, easy to manufacture and easy to use.

The methods describe herein additionally enable passive optical network discovery, and enable continuous monitoring of the optical component systems in the network. This allows for savings operations and management costs, reduces the risk of installation and connection errors, and allows for an up-to-date inventory of the network to be maintained. Additionally, these methods also allow site visits to be reduced, and resource usage to be optimised as the characteristics of the remote optical component systems may be determined according to the updated inventory.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-29. (canceled)

30. A method for determining information associated with an optical component system in a network, wherein the optical component system comprises a first optical path for transmission of a first optical signal, wherein the first optical path operates in an optical bandwidth that is different from a traffic optical bandwidth of a traffic optical path, the method comprising:
detecting at least one mechanically introduced optical loss in the transmitted first optical signal; and
based on the detected at least one mechanically introduced optical loss, determining information associated with the optical component system.

31. The method according to claim 30, wherein the information comprises location information, and wherein the step of determining location information associated with the optical component system comprises:
determining a distance at which the at least one mechanically introduced optical loss in the first optical path occurred; and
based on the determined distance, determining location information associated with the optical component system.

32. The method according to claim 31, wherein the method further comprises:
based on the determined distance, determining identification information associated with the optical component system, wherein the identification information is also associated with the determined distance.

33. The method according to claim 30, wherein the information comprises identification information, wherein the step of detecting at least one mechanically introduced optical loss in the transmitted first optical signal comprises:
detecting a plurality of mechanically introduced optical losses in the first optical path of the optical component system,
and wherein the step of determining location information associated with the optical component system comprises:
based on the detected plurality of mechanically introduced optical losses, determining identification information associated with the optical component system.

34. The method according to claim 33, wherein the identification information is encoded by the detected plurality of mechanically introduced optical losses.

35. The method according to claim 33, wherein determining the identification information comprises determining whether the plurality of mechanically introduced optical losses have been detected within a predetermined distance range.

36. The method according to claim 34 wherein determining the identification information comprises decoding the encoded identification information by determining whether a mechanically introduced loss has occurred at defined points along in the first optical path.

37. The method according to claim 36, wherein the defined points are based on a pattern of mechanically introduced optical losses that would encode the identification information.

38. The method according to claim 34 wherein determining the identification information comprises decoding the encoded identification information by determining the distance between the mechanically introduced losses.

39. The method according to claim 30, wherein the step of detecting at least one mechanically introduced optical loss in the transmitted first optical signal comprises detecting at least one optical loss in a reflection of the first optical signal.

40. An apparatus for determining information associated with an optical component system in a network, wherein the optical component system comprises a first optical path for transmission of a first optical signal, wherein the first optical path operates in an optical bandwidth that is different from a traffic optical bandwidth of a traffic optical path, the apparatus comprising a processor and a memory, the memory containing instructions executable by the processor such that the apparatus is operable to:
detect at least one mechanically introduced optical loss in the transmitted first optical signal; and
based on the detected at least one mechanically introduced optical loss, determine information associated with the optical component system.

41. The apparatus according to claim 40, wherein the information comprises location information, and wherein the step of determining location information associated with the optical component system comprises:
determining a distance at which the at least one mechanically introduced optical loss in the first optical path occurred; and
based on the determined distance, determining location information associated with the optical component system.

42. The apparatus according to claim 40, wherein the method further comprises:
based on the determined distance, determining identification information associated with the optical component system, wherein the identification information is also associated with the determined distance.

43. The apparatus according to claim 40, wherein the information comprises identification information, wherein the step of detecting at least one mechanically introduced optical loss in the transmitted first optical signal comprises:
detecting a plurality of mechanically introduced optical losses in the first optical path of the optical component system,
and wherein the step of determining location information associated with the optical component system comprises:
based on the detected plurality of mechanically introduced optical losses, determining identification information associated with the optical component system.

44. A fiber presser comprising:
a housing for directing an optical fiber; and
a plurality of projections, wherein each of the plurality of projections are moveable between a first position in which the projection induces a mechanical optical loss along an optical fiber, and a second position in which the projection does not induce a mechanical optical loss along the optical fiber; wherein the plurality of projections are configured to induce mechanical optical losses along the optical fiber that encode information along the optical fiber.

45. The fiber presser according to claim 44, wherein the fiber presser further comprises a biasing element configured to bias the plurality of projections to remain in either the first position or the second position.

46. The fiber presser according to claim 44, wherein the each of the plurality of projections are rotatable about a first axis between the first position and the second position.

47. The fiber presser according to claim 44, wherein the encoded information is associated with an optical component system.

48. The fiber presser according to claim 44, wherein the housing is configured to coil the optical fiber around a second axis.
